(19) United States
(12) Patent Application Publication
(10) Pub. No.: US 2022/0315265 A1
(43) Pub. Date: Oct. 6, 2022

(54) Apparatus and Method for the Provision of Labels

(71) Applicant: Avery Dennison Corporation, Mentor, OH (US)

(72) Inventor: Michael John Cooper, Wetherby (GB)

(21) Appl. No.: 17/635,626

(22) PCT Filed: Aug. 21, 2020
(86) PCT No.: PCT/GB2020/052025

§ 371 Date: Feb. 15, 2022

(30) Foreign Application Priority Data
Aug. 23, 2019 (GB) 1912131.8
Mar. 27, 2020 (GB) 2004505.0

(51) Int. Cl. B65C 9/18

(52) U.S. Cl. CPC B65C 9/1865; B65C 2009/0087

(57) ABSTRACT

A method and apparatus for reuse and/or recycling of liner material layers from a label supply which typically includes the liner material layer and a label supply material in which the labels are formed and from which the labels are subsequently applied to one or more articles. The invention allows the separation and processing and recycling of the liner material layer which, otherwise and conventionally would be treated as waste. The invention allows this to be achieved without the need for the application of any material to the label supply following the formation of the same. The recycling can be in the form of forming the liner material into a raw material for subsequent processing or, alternatively, using the liner material as an adhesive tape or, alternatively, directly reusing the liner material layer as part of another label supply.

The subject matter of the present invention is the provision of apparatus and a method to allow the provision of reels of label supply material to locations at which the labels are applied to articles, with the supply initially formed at a laminate location and provided as a laminate combination of the label supply material layer, adhesive, release coating and a liner or backing material layer from a laminate producer location, then being passed to a location of a label printer and conversion facility and then onwards to the said one or more locations at which the point of application of the labels to the articles occurs.

The invention is particularly, although not necessarily exclusively, directed towards the provision of linerless pressure sensitive (PS) labels formed from a suitable sheet material. The initial laminate which is provided conventionally includes the liner or backing material layer adhered to the label supply material layer and is transported in that form until the liner or backing material layer is separated from the label supply material layer, conventionally at the same location as that at which the linerless labels are applied to the articles. Once the liner or backing material layer is separated from the label supply material layer, the liner or backing material layer is waste material.

The use of pressure sensitive labels is well-known, and the labels are currently typically applied by releasing the same from the silicone coated liner material layer at the location of the application of the labels to the articles and at, or shortly before, the application of the label to the article. Once the labels are released from the liner material layer, the liner material layer represents a complex waste stream of small and varied width reels which are located at multiple locations which makes it difficult and expensive to collect them and then transport the same to a waste recycling location. As a result, it is estimated that millions of tonnes of liner material waste is consigned to landfill sites and will continue to do so. When one considers that the provision of this laminate comprising label supply material layer and the liner material layer, is a truly global industry with variable rates of consumption, such as ten square meters per capita per annum in developed countries down to under one square meter per capita in less developed countries, then the supply of the laminate tends to be performed by relatively large multinational manufacturers and is on a relatively large scale with machines typically being used which are 2 metres wide and producing the laminate in master reels of that width and at a 1000 metres per minute.

While the industry has recognised the need to reduce its waste footprint, and the recycling of waste liner material in the form of glassine and Kraft papers is possible, the presence of silicone as a release layer on the liner material does render the recycling more difficult as the silicone acts as a contaminant. Despite this, it is estimated that, even in developed markets, less than 10% of the annual production of liner material waste is recovered and, while new liner material is produced which includes recycled content, the continued demand for virgin fibres is still the most significant. The liner material layer of the laminate also has to have a relatively high tensile strength in order to allow the high speed, high frequency application of the labels, for example, up to 1000 labels per minute in a stop start controlled manner.

Thus, while efforts have been made to recycle the liner material, the practical implementation of known recycling methods is very low due, at least partially, to the relatively complex logistics involved in retrieving the liner material and transporting the same to a location at which the same can then be recycled.

A further problem is that due to the liner material layer being removed from the label supply material layer at the end user locations, i.e. where the labels are applied to the articles then at that point the laminate of the label supply material layer and liner material layer is provided as relatively small sized reels and so, when the liner material layer is removed, there are created large volumes of relatively small sized reels of the waste liner material and it will be appreciated that these are generated at multiple locations. It therefore proves to be particularly difficult to collect and transport multiple small reels from the number of different locations to a centralised recycling location in an economically viable manner and hence it is found that in the majority of cases, the reels of waste material are never sent back for recycling at the recycling location.

An increasingly attractive alternative is to provide reels of linerless label sheet material, i.e. without any liner material layer being provided at any stage. However while the ability to apply this type of label is proven, it is based on using printing and conversion methods which are relatively complex for the label printer and/or convertor companies and so this, alone, will not meet growing label demand and significantly reduce waste at least in the short term even though the linerless labels do allow more labels per reel to be produced for the packer, and overall reduce raw material usage and lower transport costs.

The manufacturing industry for this type of product can broadly be divided into the manufacture of labels which are provided for decoration and information in relation to individual articles, and labels for use in logistics in which variable information is usually printed as the outer packages are completed.

In the latter use there have been significant developments of a linerless alternative over many years led by individual converter's exploiting the advances in direct thermal papers. Typically, reels of 400 millimetres width of thermal paper at 150 meters per minute are processed and a converter applies a silicone release layer and a hot-melt pressure sensitive adhesive layer and then slits and rewinds the same into finished reels with, at present, the largest volume production being reels of 75 millimetres width. The development of suitable label applicators has increased for use in the packaging and the transport of goods with, typically, line speeds of 50 cases per minute and, as a result, linerless label demand has accelerated in this field which has attracted global laminate producers to supply “self-wound” linerless direct thermal master reels for the convertor to cut into smaller reels. The capacity of these major laminators is essential to meet demand and this development has demonstrated that pressure sensitive labels can be applied without a waste liner.

With regard to the field of decorative and/or informative labelling, individual articles in the form of containers, such as bottles, are typically labelled at a much higher speed, for example, clear-on-clear printed labels are applied to glass beer bottles at a rate of 1000 per minute. Packing line speeds can vary but in all current pressure sensitive label applications a high strength liner material layer is required to meet the stresses of stop/start acceleration. The industry has developed high-speed release silicone coatings which ensure that labels with adequate stiffness are separated from liners to meet these demands for speed and accuracy. The labels are separated from the silicone liner material layer at a peel plate or beak with only the liner material layer under tension.

In high volume beverage and water bottle applications, major application machine producers have developed full-wrap labelling with hot-melt application and high-speed cutting as these labels are applied to containers. While this is a different technology it is as demanding as compared to individual patch labelling. This has enabled the development of very thin and cavitated filmic wrap materials for roll fed glued labels which can only be used in full wrap labelling.

The use of linerless labels has been developed by the current applicant with reference to, for example, patent GB2185426 which uses patterns of micro-perforations imposed either by the printer or within the applicator to define the join between adjacent labels in the label material supply and allows for some shaping of the labels. As this is now technically proven and used, for example, in demanding high-speed beer bottle label applications, the pressure sensitive label supply industry is challenged to produce linerless, decorative and informative labels in volume.

In the process of forming the conventional decoration and information labels, the same are typically printed by applying ink to the external face of the label material layer, before the application of a pressure sensitive layer to the internal face and then a silicone release layer is located intermediate the adhesive and the liner material layer and, additionally, forming micro-perforations and/or cuts shapes in the die cutting or slitting station. Direct coating and die cutting present technical challenges resulting in these special machines, mainly by use of a process silicone liner which can be used many times. Linear matrix waste is produced with shapes and also in order to confirm the die cutting process has produced quality micro-perforation cuts and ties as, if a linear matrix is not released successfully, the die cutting process results are inspected.

As an alternative the label printer may now adopt a laminate to linerless option in which the label printer now decorates the face and before die cutting transfers the clear filmic liner over the printed face to protect the image and provide the release in the final self-wound reel of linerless labels. However, this alternative requires specialist converting investments and can only operate with clear liner materials and although these developments are significant, they do not address the huge volume challenge industry faces with regard to liner material waste and the increasing waste legislation which is being introduced.

Another potential problem with the waste liner material which is returned for recycling is that the material has to go through a specific recycling or waste disposal process which can itself be expensive and also, in certain instances, certain components of the waste liner material cannot be recycled and hence prevent the waste liner material from being recycled unless the components are separated.

There is therefore a need to be able to improve the viability and attractiveness of recycling liner waste material which, in addition to providing the clear environmental benefits, allow those benefits to be obtained in an economically viable manner.

An aim of the method and apparatus, is to enable and improve the efficient recycling of the liner material from the original laminate label supply. A further aim is to allow the collection of the waste material to be achieved in a manner which allows greater volumes of the waste material to be provided at one location for collection and therefore reduce the number of locations from which waste material may need to be collected to improve sustainability and reduced volumes of waste. A further aim is to allow sufficient volumes of waste material to be created at a single location so as to allow the recycling of that waste liner material to occur at the same location and thereby avoid the need for any transportation of the waste material before recycling.

A further aim is to further advance the environmental benefit of the provision of improved return of the waste liner material for recycling by allowing the reels of the liner material to be adapted for a specific use without having to be passed through chopping and recycling stages.

In a first aspect of the invention, there is provided a method of processing a labels supply from the location of the formation of a label supply laminate to a remote location at which the labels are applied to articles, said label supply laminate formed and including a label supply material layer and a liner material layer on which the said label supply material layer is adhered, said liner material layer acting as a carrier for the label supply material layer to a point of separation of the label supply material layer from the liner material layer and wherein the said point of separation is performed at a location intermediate the formation of the label laminate and the application of the labels to articles.

In one embodiment after the separation of the liner material layer from the label supply material layer the label supply is formed into one or more reels of linerless labels for onward transport to the point of application.

In one embodiment after the separation of the liner material layer from the label supply material layer the liner material layer is formed into one or more reels for movement to a recycling facility. In one embodiment the printer may stop a press to remove finished reels of the linerless label material layer but then continue to produce more of the same or a new label image from the same original master reel of laminate and in effect rewind all of that liner material layer from the master roll into one reel of waste liner material for collection.

In one embodiment the said reels of the label supply material layer which are formed are of a smaller outer diameter than the outer diameter of a reel on which the laminate is provided to the location of separation of label supply and liner material.

In one embodiment, the location at which the liner material is removed from the label material, is the location at which the labels are printed and/or converted in the label supply material and, once the printing and/or conversion has occurred, the liner material layer is removed from the label supply material layer and the label supply material layer is wound into new reels for onward supply and, subsequently application, to articles.

In one embodiment, the subsequent supply of the reels of the label supply material layer involves the transport of the same to another location at which the labels are applied to the articles.

In one embodiment the liner material layer includes a release layer which, in one embodiment, is a silicone material.

In one embodiment, at the label conversion stage protective varnishes and/or anti-release coatings are applied to the label supply material layer, typically over printed images which have been applied and prior to the definition of the labels in the label supply material layer, such as by die cutting or slitting. In one embodiment the application of the one or more coating layers can be performed in the printing press or a separate label reel finishing machine.

In one embodiment, a cutting module, such as a die tool or rotary slitter, are provided to cut only the label supply material layer to define the final label format and/or form micro-perforations which are to be subsequently separated at the point of application of the label to the article via label applicator apparatus.

In one embodiment, the label convertor strips of selvage edge print waste and/or matrix waste from the label supply material layer which is left after the definition of the labels is removed as a separate stage to the stage of removal of the full width of the liner material layer which is progressively stripped from the label supply material layer, typically under tension in a rewinding apparatus. In one embodiment the removal is along a line running substantially parallel to the longitudinal axis of the reel of laminate.

In one embodiment a peel plate or a transfer pulley is provided and smaller reels of the separated and now linerless label supply material layer are formed simultaneously and typically located side by side with spaces between resulting from the linear face material waste removal.

Typically the liner material layer which is now waste, is re-wound into a reel to allow the same to be conveniently transported for recycling and therefore, in accordance with the invention, the liner material layer does not reach the location at which the point of application of labels to the articles occurs and which in one embodiment may be a geographically separate location.

In one embodiment, the lanes or paths of linerless labels are carried by the liner material until the liner material is stripped or separated therefrom and this may be assisted by a plasma coated drive pulley running on the adhesive face of the labels or a suitable nip assembly at a speed and tension which creates the force required to achieve separation from the liner material on a continuous basis before the individual reels of self-wound linerless label supply are completed. These finished reels are wound under minimal tension to eliminate the risk of adhesive leakage at the edges of these reels.

In one embodiment the linerless label supply with lines of weakening formed thereon the same is supported on its separation from the liner. In one embodiment, the linerless label supply material layer face is held secure by a vacuum segment of a contact means which, in one embodiment may be a rotating cylinder which typically, is operating at a conversion defined web speed. In one embodiment, the vacuum is selectively blocked at the external face of the cylinder so that the liner material layer is not similarly held or controlled and is stripped under tension at a peel plate or driven path pulley whilst the label supply material layer face is supported and so ensuring that that there is no tension applied to the lines of weakening in the linerless label supply material layer as the liner material layer is stripped.

In one embodiment the labels are defined by die cutting or otherwise forming micro-perforations into the label supply material layer and in one embodiment the amount of material cut is 75% of the overall width of the label outline and by separating the liner material from the label supply material layer as herein described in accordance with the invention it may be possible to further increase the percentage of cut and thereby facilitate alternative application mean for the labels onto the articles, such as by vacuum pad transfer.

In one embodiment, the liner material layer used is a paper based liner having a reduced tensile strength and it is ensured that a label supply material layer of adequate tensile strength is released. In one embodiment, the liner material includes a release coating which is more readily recycled than a silicone release coating. In one embodiment, the said release coating is a water-soluble coating which can be subsequently removed or washed off the liner material to further improve the ease of recycling the liner material.

Typically the control parameters used to separate and apply a pressure sensitive label to an article from a conventional liner material differ to those required to separate the label supply material layer under tension from a recyclable liner material.

The release force measurement using a relatively high stripping speed of the liner material from the label supply sheet material is typically >50 m/min whereas a slow speed release, by contrast, is a force measurement using a relatively slow stripping of 0.3 meters/minute. The tensile strength of 45 gsm glassine liner is Tensile Strength MD (kN/m) 4.5, 58 gsm which has a calliper of 51 microns is 6.4 and most paper liners are also in this range.

In one aspect of the invention which can be used in conjunction with these aforementioned features or independently thereof, the label supply sheet material with the labels having been defined therein has a pattern of surface cuts on said labels which are aligned in the same direction as the label is fed to the article to which it is to be applied.

Typically, the said surface cuts facilitate accelerated removal of the label from the article to which it has been previously applied and most typically as part of a subsequent recycling process for the article and label combination. In one embodiment the said surface cuts allow the ingress of removal liquids so as to allow washing of adhesive from the label and thereby improve the speed of removal of the label. These cuts are therefore typically provided in the final label at the same time as, or after, die cutting lines of weakening into the label supply material layer and possibly not in the original label supply material delivered by the laminator to the printer.

In one embodiment a water based or alternative liquid wash-off procedure is used in the article recycling. In one embodiment said cuts are disguised or masked by alignment with artwork images on the labels.

In one embodiment, the liner material is a filmic liner coated with a non-silicone release material to enable the fully recovered liner to be completely reprocessed into the original wide web format required for laminate production.

In one embodiment, there is provided a label supply material layer in which micro-perforation ties within a line of weakening are varied and/or a surface label cut pattern provides an anti-counterfeit pattern change which can be revealed, in one embodiment, only under a magnified view of the applied label.

In one embodiment, the adhesive used for the label supply material layer has a relatively high cohesive strength and relatively strong affinity for the face of the label supply material layer and a lower affinity for the liner material layer.

In one embodiment the said separated liner material layer is formed into an adhesive tape with on a first surface a coating of release material and, on the opposing surface, a coating of an adhesive material.

In a further aspect of the invention there is provided a master roll of laminate produced by a laminate manufacturer and which includes a label supply material layer which includes a surface for printing thereon, an opposing surface with a layer of adhesive, a liner material layer to which the label supply material layer is initially adhered in the master roll and a release system between the liner material layer and label supply material layer and wherein said liner material layer and label supply material layer are separable and at least the label supply material layer is formed into a plurality of smaller reels for onward supply to one of more points of application of the labels therefrom to articles.

In one embodiment the master roll is at least 2 meters in width

Typically the separated liner material layer is recovered and recycled to become useful material and in one embodiment is formed into a reel of the said material.

Typically, the master roll is slit, printed, release coated and pre-weakened, such as by die cutting, at the same location as which the separation of the liner material layer and label supply material layer occurs.

In another embodiment, the liner material which can be paper or film is provided with a surface which has been mechanically modified to provide relatively low-surface energy so as to be separable from the adhesive at the separation step without damaging the laminate. In this method, the liner has no chemical modification and can be directly recycled back into either the production of a new liner or more useful products.

In another embodiment, there is provided a liner material of paper or film for which the surface has been modified chemically so as to reduce it's surface energy rendering its strippable. Preferably the modification is such that the liner material can be considered to be either not contaminated or to have minor contamination so that it can be recycled into potential subsequent usage streams.

In a further embodiment, there is provided a liner material which is of paper or film which has been treated with a release chemistry which can be removed prior to recycling so as to increase the number of options for which the liner material can be usefully added.

In one embodiment, the release coating material is of a type to allow the same to be washed off or otherwise removed, such as by mechanical abrasions such as milling prior to recycling.

In a further aspect of the invention, there is provided apparatus for the processing of label laminate including a label supply material layer and a liner material layer onto which the said label supply is adhered, movement means which allow said liner material to act as a carrier for the label supply as the laminate is moved to a point of separation of the label supply from the liner material and wherein the point of separation of the label supply from the liner material is intermediate the formation of the label laminate and the point of application of the labels defined in the label supply material layer to articles and separation means include stripping means to strip the liner material from the label supply material layer and for winding and cutting at least the label supply material layer into a series of reels of a smaller width than the said reel on which the laminate is supplied.

In one embodiment, after separation, only the labels defined in the label supply material layer are supplied in reels to the point of application to the articles.

In a further aspect of the invention, there is provided an adhesive tape, said adhesive tape comprising at least one sheet material layer having, on a first surface, a coating of a release material and, on the opposing surface, a coating of an adhesive material.

In one embodiment the said adhesive material is rendered adhesive by an activation stage.

In one embodiment, in a first mode, the said sheet material layer is formed by liner material previously provided as part of a label supply. Typically therefore the said sheet material layer has previously had a label supply layer applied over the said release coating to form the label supply. In one embodiment the said label supply layer has a plurality of labels defined along a linear axis, and said label supply layer is removed from the said sheet material layer to form a linerless label supply and at a subsequent stage, the labels are sequentially detached from the linerless label supply from a leading edge of the same.

In a further aspect of the invention, there is provided apparatus for the formation of an adhesive tape, said apparatus including a means of forming a label supply including a liner material layer, a label supply material layer in which one or more labels are defined and which has an adhesive on a surface thereof and which is applied to a release material applied to a surface of the liner material layer, said apparatus includes means to separate the liner material layer from the label supply material layer to form the label supply material layer into a linerless label supply from which labels can be subsequently detached, and wherein means are provided to wind the separated liner material layer into one or more reels and to apply and/or activate an adhesive on a surface of the said separated liner material layer so as to form the same into a reel of adhesive tape.

In one embodiment the said adhesive is located on the surface of the liner material layer which opposes the surface on which said release material is applied.

In one embodiment the means for applying adhesive is located so as to apply the adhesive in a non-activated manner onto the liner material layer prior to the label supply being formed.

In an alternative embodiment the means for applying the adhesive is located so that the adhesive is applied onto the liner material layer surface after it has been separated from the label supply layer.

Typically the label supply or backing layer, means are provided to apply a coating of an adhesive so as to form the said adhesive tape supply.

In one embodiment, there is further provided apparatus for the application of labels from the linerless label supply wherein said apparatus comprises means for removing said one or more labels to apply the same onto one or more articles.

In one embodiment there is therefore provided the ability for the recovery of liner material at the label supply convertor in order to allow the liner material to be recycled, typically chemically, back to the original monomers.

In a further aspect of the invention, there is provided a method for forming an adhesive tape from a liner material layer previously used in conjunction with a label supply material layer to form a label supply; said method comprising the steps of applying to the liner material layer a coating of a release material, applying to said release material the label supply material layer, passing the label supply to conversion apparatus to allow printing and/or forming of labels on the label supply material layer and wherein said liner material layer is removed from the label supply material layer which is passed to label application apparatus and the said separated liner material layer includes an adhesive material applied to a surface to form the same into an adhesive tape.

In one embodiment the method includes the steps of cutting the liner sheet material into strips and/or winding the liner sheet material into reels.

The invention therefore allows the efficient collection and recycling of the liner material and other waste material.

Specific embodiments of the invention are now described with reference to the accompanying drawings wherein:

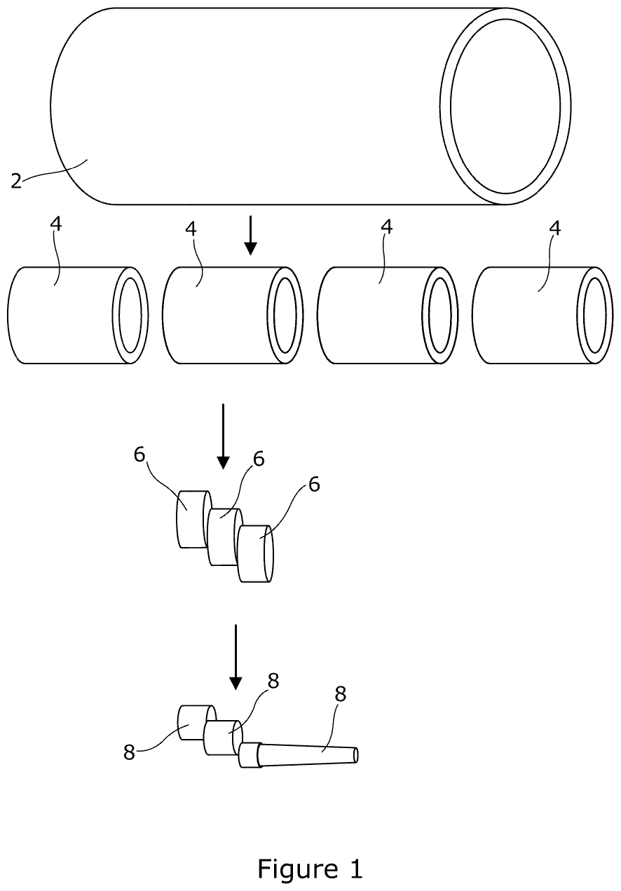

FIG. 1 illustrates a conventional method for the provision of a laminate and provision of labels to the point of application to articles;

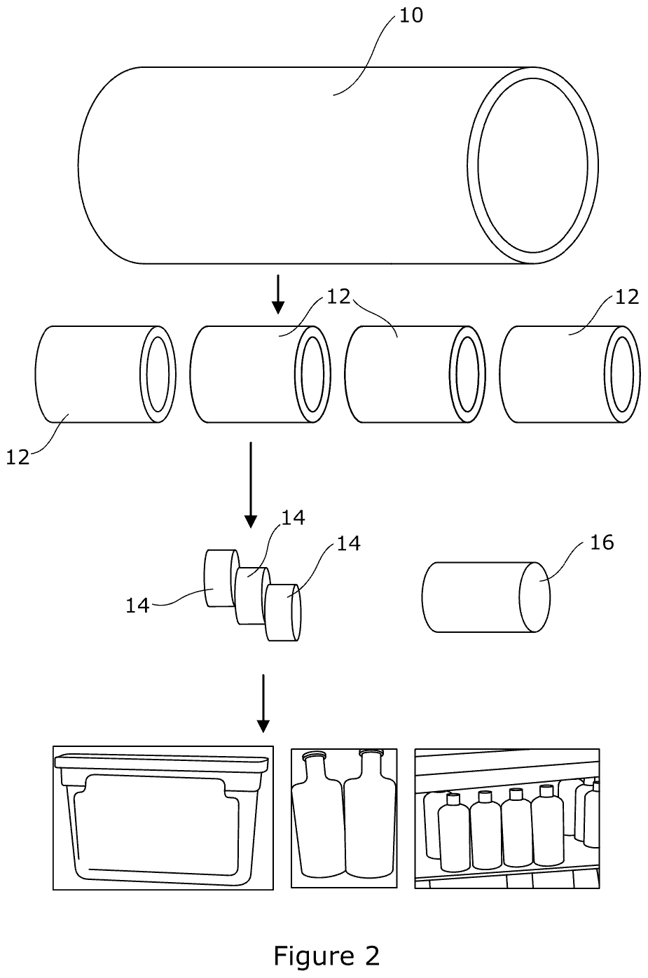

FIG. 2 illustrates a method in accordance with the invention in one embodiment;

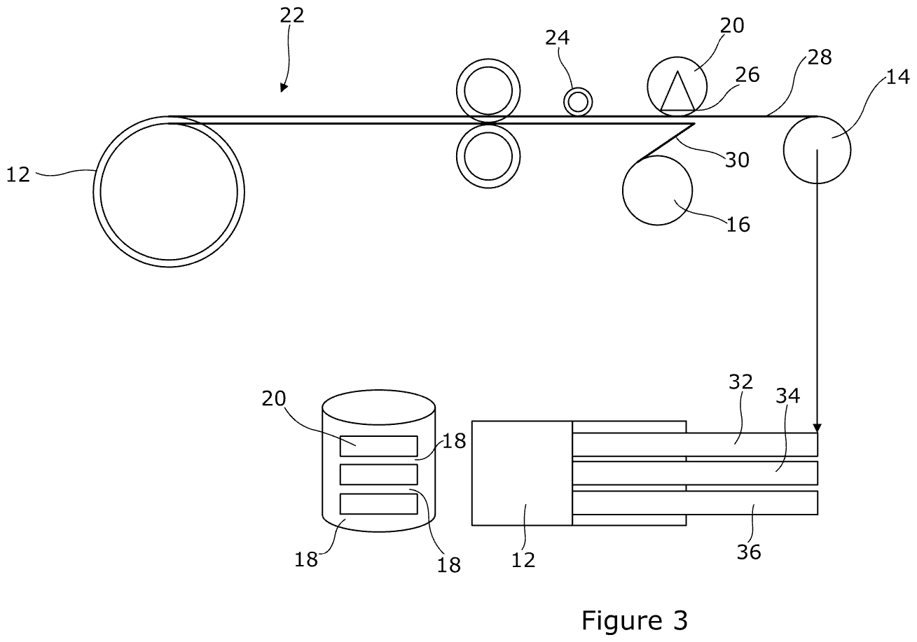

FIG. 3 illustrate an example of a conversion system and apparatus in accordance with the invention;

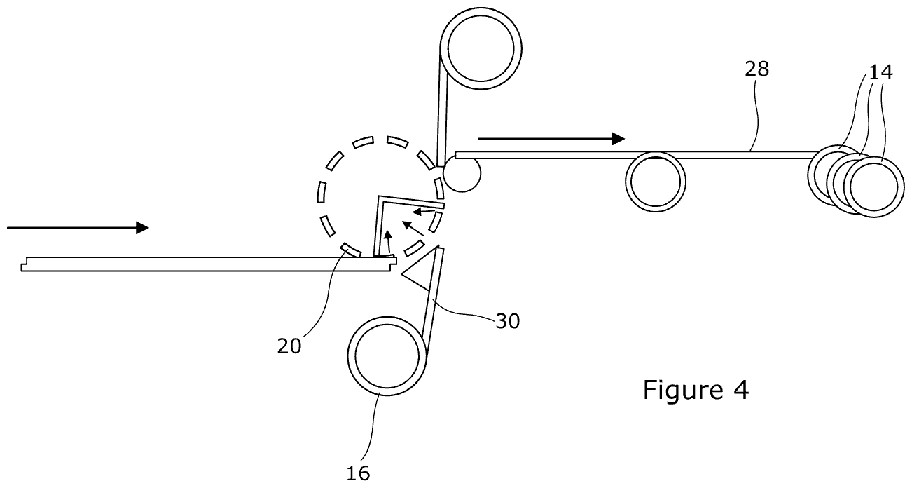

FIG. 4 illustrates a further embodiment of apparatus in accordance with the invention;

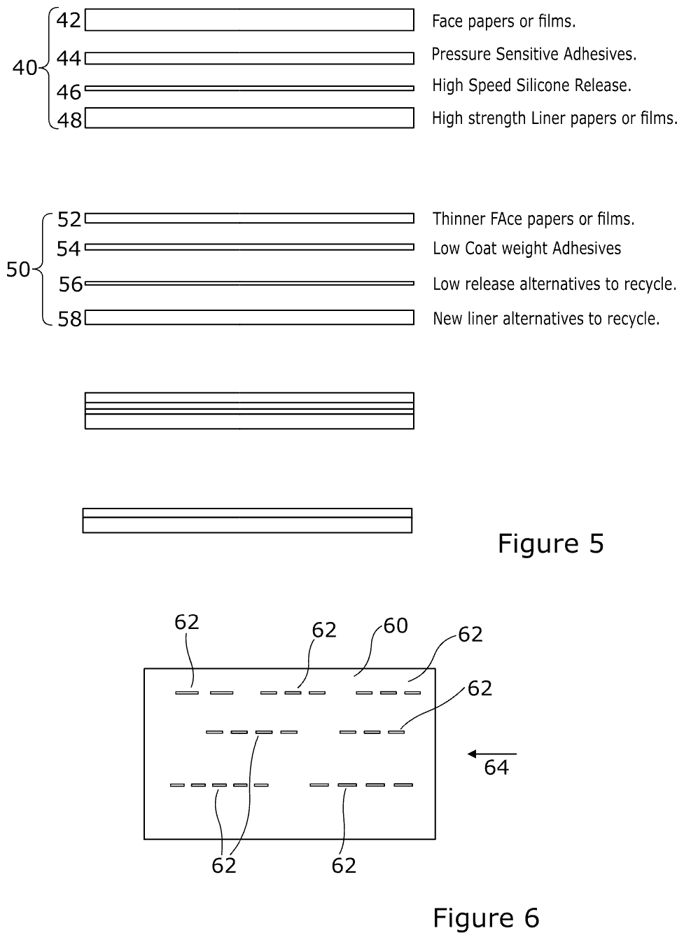

FIG. 5 illustrates the manner in which the different forms of laminates may be created for use in the current invention;

FIG. 6 illustrates a label defined in the label supply material layer in accordance with one embodiment of the invention;

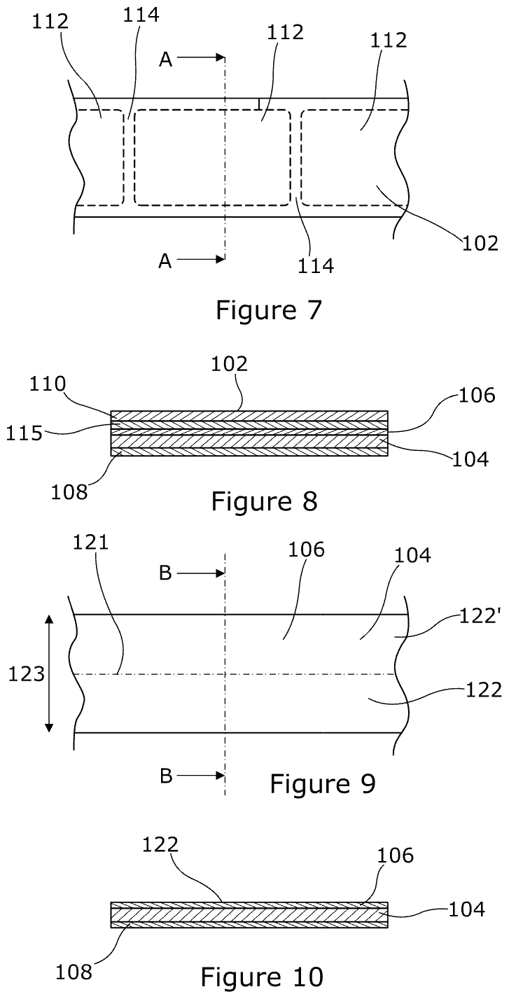

FIG. 7 illustrates a label supply in accordance with a first condition in plan in accordance with an embodiment of the invention.

FIG. 8 illustrates the label supply of FIG. 7 in cross-section along line AA.

FIG. 9 illustrates an adhesive tape in plan in accordance with one embodiment of the invention.

FIG. 10 illustrates a cross-section through the adhesive tape of FIG. 9 along line BB;

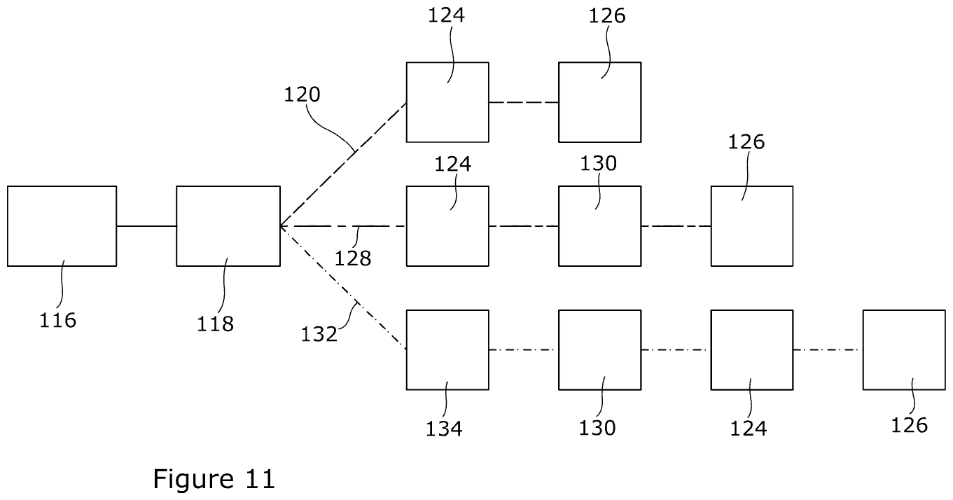

FIG. 11 illustrates, in a schematic manner, embodiments of the formation of the label supply of FIG. 7 to the adhesive tape of FIG. 9; and

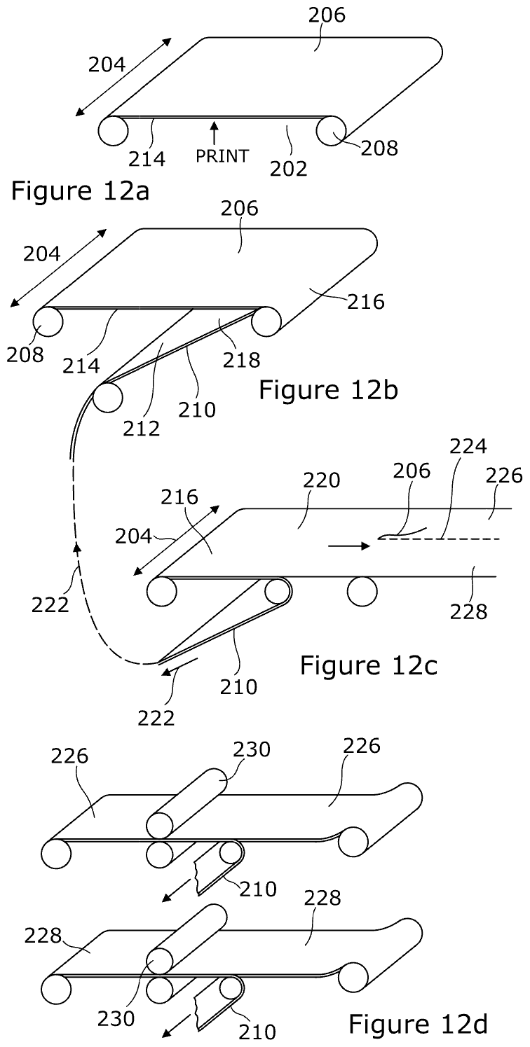

FIGS. 12a-d illustrate a further embodiment of a process in accordance with the invention.

With regard to FIG. 1, there is illustrated a conventional label laminate and this uses the provision of a master roll 2 of laminate which is produced by the laminate manufacturer and is typically of 2 metres or more width and includes a liner material layer which carries thereon, and which has adhered thereto, a label supply material layer.

The master roll 2 of laminate is then provided with cuts at intervals along its width to form a series of smaller reels 4 of laminate typically of 1 metre outer diameter and these reels are then supplied to a printer and label conversion company location at which the labels are printed on the laminate and then cut again into smaller reels of label laminate 6. Typically, during this process around 10% of the laminate is discarded. These smaller reels 6 are then passed to a “packer” company which then distributes the reels of the laminate to the company location or locations at which the labels are applied to articles to form, typically a retail package and the label supply material layer is conventionally separated from the liner material as the labels are applied to the articles. The liner material, which is now waste, is provided as waste reels 8 which can easily telescope due to the silicone release coating material. The aim is for these to be collected and transported for recycling but, in practice this rarely happens.

The current invention now overcomes this problem so as to create the significant improvement to the waste material footprint and laminate supply logistics, including also the possibility of new laminate types.

The first stage of the invention, as shown in FIG. 2, is again to provide a master reel 10 of laminate from the manufacturer and the master reel is cut into smaller reels 12 and supplied to the printer and convertor location and the separation of the label supply material layer from the liner material now occurs at this location. This therefore means that from the printer and convertor location there is provided reels 14 of linerless label supply material to the label application company location or locations. The liner material is now waste at this location and can be made available typically as a reel 16 which is not passed to the label application location but rather can be collected for recycling. It will therefore be appreciated that the size of the reel 16 of the waste liner material is greater and the number of locations at which reels of waste material are located is greatly reduced in comparison to the conventional method and so there is a greater likelihood for the collection and hence recycling of the waste liner material to be performed than in the conventional method.

The apparatus provided to allow the separation of the liner material from the label supply material layer can take several forms to suit particular requirements. The method introduces the separation of the lining material from the label material across the full width of the reel at the printer convertor location and then rewinding and separation techniques are used to ensure the linerless label supply material layer is secured into reels 14.

In FIG. 3 the reel 12 is provided at the converter location and face printed and a release coating layer 22 is applied thereto and any linear edge and shape waste of the label supply material is removed 24. An optional cylinder 20 is located at station 26 and this assists in the separation of the label supply material layer 28 to be formed into reels 14 of linerless label supply material for onward supply to the label application location. The separated liner material 30 is reeled to form the liner material waste reel 16. It is also illustrated how the reel 12 is progressively processed to provide the three paths 32, 34,36 of linerless label supply sheet material and each of which is wound to form a respective reel 14.

The addition of liner separation and winding to a press or offline finishing machine allows the label convertor, when producing conventional labels, to rewind this edge slip waste material separately from the liner material waste. Present methods generally back slit the edge liner and collect this trim with all matrix waste. The optional segment vacuum cylinder 20 as shown in an example of the apparatus in FIGS. 3 and 4 can be used as an alternative path guide for linear and liner material matrix waste removal when producing the linerless or conventional labels in upgraded apparatus. This example allows the transfer of the die cut and face waste stripped web to be controlled by vacuum segments 18 in the rotating cylinder 20 which hold the non-adhesive material by vacuum at certain locations. Thus, in different embodiments, the waste material can be separated from the label supply sheet material before or after the location of the vacuum cylinder. The specific locations at which the vacuum acts can be preset on the cylinder itself or can be defined to suit particular usage requirements, such as by applying tape or other blanking material onto the surface of the cylinder at those locations where the vacuum effect is not required. Thus, the pattern of the vacuum segments on the cylinder can be configured to align with the linear edge and shape label waste pattern of the laminate to ensure no loss of vacuum control of the individual linerless label supply material paths whilst still carried on the liner material. The liner material release surface, which may be exposed by removal of the linear strip waste before this rotating cylinder, is unaffected by the vacuum.

It is conveniently stripped over a full reel width peel plate before the supported label supply material exits the vacuum segment. This label supply material may retain the linear strip waste now separated at this same cylinder as the linerless label supply material paths are directed toward the reel winding. The method thus frees the linerless label supply material from vacuum control after the vacuum segment and after the full width stripping of the liner material and can be re-wound under the lower reel tension best used for all self-wound linerless label supply material reels.

These alternative embodiments ensure that the lines of weakening which are created by the micro-perforations in the label supply material layer in order to define the labels are not stressed as the liner material layer is stripped from the label supply material layer using the peel plate or a driven path roller alternative.

This ensures that the production of label supply material and PS adhesive and the volume of production is still viable.

FIG. 5 illustrates the manner in which the different forms of laminates may be created for use in the current invention. Laminate 40 is a conventional laminate which includes a label supply material layer of paper or film 42 which meets the required stiffness parameters, a pressure sensitive adhesive 44, a high speed silicone release layer 46 and a liner material layer of paper or film 48.

In accordance with the invention embodiments of alternate laminates 50 could be used, one of which includes a label supply material layer in the form of a thinner face paper or film 52 and a low coat weight adhesive layer 54 with a liner material layer 58 and a release coating 56 which is particularly suited for recycling purposes.

The impact of this method supports logistics innovation and potentially means that brands do not have to evaluate and approve new face materials and adhesives in order to adopt the change to linerless labels which frees them of waste and increases their efficiency. It is anticipated that the supply of linerless label supply material to the label application locations should have no significant impact as the majority of production lines can conveniently adapt label applicators to a linerless format whilst running down existing stocks and change artworks in the usual cycle and in a climate of heightened waste concerns, the incentives are significant.

The change to linerless conversion is far less complex with a printer convertor and does give additional impetus to an industry trend to separate web printing and final converting. The growth of Just in Time digital printing has contributed to overall laminate material savings by faster setups but has not eliminated the generation of liner waste at the point of application of labels to the articles and hence the continued low recycling rates.

Laminate suppliers are unaffected as a first response to a packer and brands of created PS linerless is a need for the printer to add a waste liner stripping and re-winding it before existing label reel winding systems are to advantageously upgrade this. When completed, the benefits of liner waste collection for enhanced recycling logistics is immediate.

For the label printer, linerless label supply material conversion is far less complex than the previous options described. The full range of adhesives are supplied as specified to meet all current label applications and most labels are protected by varnish and substitution by a silicone modified release alternative is practical. Die cutting is conventional and has a significant benefit over laminate to linerless as the liner is stripped and is no longer required for label application and so minor damage to the liner will not create quality related waste.

For the laminate supplier, the fully recovered volume of liner increases the potential to increase the mix of recycled material in the supply to advantage. The inventive methods introduce potential for new laminate constructions which can be produced by the laminate community on their own current assets with minimal investment and which can now be more specially designed for recycling.

Laminates with reduced face material 52 are provided to exploit the fact that linerless label application methods do not require the stiffness of a conventional label, laminates with the reduced specification of paper release liner can exploit the fact that this liner is now used only as a carrier and the protection of the material facing adhesive, laminates with release functionality changes exploit the fact that release now only relates to stripping the liner from continuous webs of labels, both under controlled tensions.

In accordance with the invention, the liner and the webs of linerless labels all of which are continuous, are separated under tension which must exceed the release value in the liner release coating. Assistance may be required to ensure that the labels within these webs do not separate under any increased release force.

Laminates with reduced adhesive coating weights of 12 micrometres or less can exploit the fact that the current degree of protection in die cutting is reduced and the thinner faced materials or the PS linerless labels require less adhesive to be secured to the container or package.

The substitution of silicone as a release layer coating by, for example, a coating which can be washed off by water prior to final re-pulping of the waste papers aids the recycling process further. Filmic liners without silicone coating using slip agents or alternatives to silicone may be reground and reprocessed conveniently.

The recycling of liner material is therefore encouraged with the printer/converter now responsible for the waste effectively originated by the laminators and avoids the conventional complex logistics of more than one printer supplying a brand and which is a significant reason why conventionally less than 10% of liner material waste is recycled in well-developed markets. This encourages improvements to the final removal of labels from containers and packages for package recycling.

As illustrated in FIG. 6 disguised label faced cut patterns of cuts or slits 62 in the label supply material layer 60 which can be provided adjacent or within printed images on the label supply material layer means that the cuts or slits are not readily apparent to the purchaser or user of the article to which the labels are applied. The cuts or slits 62 are imposed to be parallel to the direction of movement 64 only and these cuts are therefore not stressed in label separation from the liner or when the label is applied. The cuts or slits 62 improve wash off processes to allow penetration to the reduced adhesive layer to advantage. Furthermore, the provision of simplified die cutting lines or weakening for the linerless label supply sheet material will encourage brands to exploit the anti-counterfeit feature available by periodic changes to the patterns of micro-perforations between catchpoint format labels. Minor, almost invisible change to these patterns and any surface slits only require die tool changes and the improvements secured by the methods and new laminates will be commercially attractive compared to many anti-counterfeit alternatives.

Referring now to FIGS. 7 and 8, there is illustrated a label supply 102 in accordance with a first condition in accordance with a further embodiment of the invention.

The label supply comprises a liner material layer 104 which acts as a liner and has a surface with a release material 106 applied thereto and, on the opposing surface, a layer of adhesive material 108 is applied thereto, or is subsequently applied thereto.

A label supply material layer 110 is provided in which a plurality of labels 112 are defined, typically at a conversion location by cut lines 114 to form a label matrix as shown and/or the application of printing. The said label supply material layer 110 has an adhesive material 115 and this is applied to the release coating 106 of the liner material layer 104 so as to form the label supply which, typically, is wound into a roll form for transport to the conversion location.

As shown in FIGS. 9 and 10, the separated liner material layer 104 has the release layer 106 forming the “top” surface and on the opposing surface adhesive material is applied and thereby forms an adhesive tape 122. There is also shown a broken line 121 which indicates that at the stage of separation of the liner material layer 104 the same can be cut along it's length to form two, or more, reduced width adhesive tapes 122,122′ but this step is optional and a decision can be made with regard to the width 123 of the liner material layer 104 and the desired width of the adhesive tape which is to be formed.

Turning now to FIG. 11 there is illustrated in a schematic manner several options of the process of the current invention. A first stage 116 is to produce the label supply and then a second stage is to convert the label supply typically by cutting and/or printing at stage 118 into the form shown in FIGS. 7 and 8. When the label supply is formed it will typically be formed into a roll for storage and/or transported to the label printer 118 and in one embodiment may already have adhesive material applied thereto and which may be activated to a PS function by the label printer as the liner material layer is processed and slit into typical tape widths of between 20 mm to 70 mm and then formed into reels. It is envisaged that the unwinding of these reels of tapes for subsequent use would be no different from conventional reels of adhesive tapes.

As an alternative to providing the adhesive on the liner material layer at the laminating stage, the adhesive may be applied at the time of removing the liner material layer from the label supply material layer, typically at or just after the label printing stage, such as, for example, via a hot melt coating apparatus.

Furthermore, the provision of PP liner material with, for example, a plasma release coating will function as the release from the adhesive.

Once the tape 122 has been formed there are a number of different options available in accordance with the invention.

A first option, indicated by broken line 120 is for the adhesive tape 122 to be moved directly to a point of use. The tape, if necessary, can be moved past activation means 124 which are designed to apply heat and/or pressure and/or any other means necessary to activate the adhesive 108 to cause the same to have adhesive characteristics and hence allow the adhesive tape 122 to be applied in the required manner. It should be appreciated that the specific activation means which are used will be dependent upon the particular adhesive used. In this embodiment the activation can take place at or adjacent to the label conversion apparatus 118 or the adhesive tape application apparatus 126 via which strips of the adhesive tape can be separated and applied in a conventional manner to articles. Alternatively, the adhesive layer can be applied to the tape at this stage.

In an alternative embodiment indicated by broken line 128 the adhesive tape 122 can again be passed to adhesive activation or adhesive application means 124. However rather than apply the tape at this stage the adhesive tape reel is moved to storage 130 and then moved from storage 130 to the adhesive tape application apparatus 126 and applied.

A third option, indicated by broken line 132 is for the adhesive tape 122 to be wound into a reel at stage 134 and then moved to storage 130 and, once removed from storage for use, the tape 122 is moved past activation means 124 to activate the adhesive layer 108 at that stage and then moved to adhesive tape application apparatus 126 for the application of strips of adhesive therefrom. In whichever embodiment the filmic material used for the liner material layer can be changed to the initial monomers of the material to thereby aid subsequent recycling or reuse of the material. There is therefore provided a cost effective method of recovering the liner material layer. Furthermore, it allows the liner material layer to be economically, and with reduced transport requirements, collected and recovered in relatively large quantities at the location at which the liner material layer is separated from the label material layer, typically at the label convertor location rather than the final label application location, and at which quantities of the liner material would be relatively small and, as a result, uneconomical to collect. This is particularly important with regard to technology which is rapidly emerging that will allow the cost effective recycling of plastics, such as PET, and which will allow, for example, PET liner material to be recovered, depolymerized and then repolymerized to form virgin PET. This will enable a truly circular economy so that in effect the liner material layer will be used over and over again, with only the relatively thin silicone release layer being consumed each time. This solution depends on a cost effective route to recovery of the liner material layer and which is now provided in this invention as the current invention allows recovery of the liner material layer at an intermediate location, such as at the label supply convertor location, which is a much more concentrated location as the converter location typically serves 100+ label application locations, and therefore the level of liner material now removed at the converter location is much greater and the number of recovery locations is much reduced. and makes the prospect of recycling economically viable

FIGS. 12a-d illustrate a further embodiment of a process for reusing the liner material layer in accordance with the invention.

In FIG. 12a there is shown the initial printing stage 202 on the reverse face 214 of a clear filmic label supply material layer 206 as currently completed by some label converters in high speed printing units at 1 metre web widths 204. This print process enables the use of metallic inks for high quality decorative effects without the waste associated with conventional foiling techniques. In FIG. 12b the printed label supply material layer 206 is passed from the roller 208 to move the same into a conventional laminate label supply 216 and the conversion is improved over the conventional method by use of a pre-siliconized PET material layer 210 and coating a high speed release silicone 212 on the open face of label supply material layer 206, and coating a clear pressure sensitive 218 on top of the original PET pre-siliconized liner and laminating the liner material layer 210 to the printed face 214 so as to create the laminate label supply 216 ready for die cutting to form conventional labels and which also causes the layer of adhesive to transfer to the face 214 of the label supply material layer.

This process now uses a repeated reused pre-siliconized PET liner material layer 210, and as a result changes the silicone coating capacity to coat the face of the printed label supply material layer 206 as well as adding the same clear PS adhesive. By this means the process creates the release surface of the final Linerless label and allows the pre-siliconized liner material layer 210 to be removed for reuse as shown in FIG. 12c in which the liner material layer 210 is separated from the label supply material layer 206 at location 220 and the liner material layer 210 is returned to be reused for a new laminate as indicated by arrows 222 at the stage shown in FIG. 12b.

The die cutting of the conventional labels in the label supply material layer 206 is typically in 500 mm wide webs and hence the original 1 meter wide laminate is slit into two widths 226, 228 at location 224 and moved onto separate reels before the die cutting process and finishing of the conventional labels in typical slitter rewinds.

FIG. 12d details the linerless label alternative in accordance with the invention and in a new conversion process the original 1 meter wide pre siliconized PET liner material layer 210 is separated for continual reuse and only the label supply material layer 206, now coated with a release layer is slit. Within the new conversion the separated label supply material layer 206 with the adhesive layer thereon is slit to form the two widths 226, 228 and is laminated onto 500 mm wide reels of other reels of reused PET siliconized liner which carries the label supply material layer portions 226, 228 through the die cutting process 230 to impose shape and or micro-perforation patterns before the liner material layer 210 is separated and the now linerless label supply material layer portions 226, 228 are independently wound into reels. This secondary use of a pre-siliconized liner allows similar frequent reuse in the final die cutting process and the new conversion process delivers the efficiency of Linerless labels in high volume markets whilst retaining proven decorative appeal.

There is therefore provided in accordance with the invention a method and apparatus for the re-use and/or recycling from label supply liner material and which therefore utilises material which otherwise would be treated as waste and to achieve the same without the need for the application of any material to the labels stock following the formation of the same. Furthermore, in terms of recycling, this means that the liner material if used as an adhesive tape and applied to cardboard boxes for example, would be a part of cardboard waste which is classified as packaging waste where European regulations do not restrict movements between countries, as compared to special waste which the liner waste material, if on its own, could be classed as and in which case significant documentation and time is required. The invention also adds the advantage that the liner material does not need to be collected for recycling, as it is “Reused”

1. A method of processing a labels supply from a location of a formation of a label supply laminate to a remote location at which labels are applied to articles, said method comprising:
said label supply laminate formed and including a label supply material layer and a liner material layer on which the label supply material layer is adhered,
said liner material layer acting as a carrier for the label supply material layer to a point of separation of the label supply material layer from the liner material layer, and
wherein the point of separation is performed at a location intermediate the formation of the label laminate and an application of the labels to the articles.

2. The method according to claim 1 wherein after separation of the liner material layer from the label supply material layer, the label supply material layer is formed into one or more reels of linerless labels for onward movement to a point of application of the labels to the articles.

3. The method according to claim 2 wherein the onward movement of the reels involves transport of the same to the remote location at which the labels are applied to the articles.

4. The method according to claim 1 wherein after the separation of the liner material layer from the label supply material layer, the liner material layer is formed into one or more reels for movement to a recycling facility.

5. The method according to claim 4 wherein the reels of liner material which are formed are of a smaller outer diameter than an outer diameter of the reel on which the label supply laminate is provided to the location of separation of the label supply material layer and liner material layers from said laminate.

6. The method according to claim 1 wherein the location at which the liner material layer is removed from the label supply material layer is at a location at which the labels are printed and/or converted on the label supply material layer

7. The method according to claim 6 wherein once the printing and/or conversion has occurred, the liner material layer is removed from the label supply material layer.

8. The method according to claim 1 wherein the liner material layer includes a release material layer.

9. The method according to claim 6 wherein the label conversion includes an application of protective varnishes and/or anti-release coatings to the label supply material layer to overlie printed images which have been applied.

10. The method according to claim 9 wherein application of the protective varnishes and/or anti-release coating occurs prior to a definition of the labels in the label supply material layer.

11. The method according to claim 6, wherein a cutting module is provided to cut only the label supply material layer to define a final label format and/or form micro-perforations which are to be subsequently separated at the point of application of the label to the article via label applicator apparatus.

12. The method according to claim 1 wherein selvage, print waste and/or matric waste from the label supply material which is left after a definition of the labels in the same, is removed from the label supply material layer separately to the separation of the liner material layer.

13. The method according to claim 1 wherein the liner material layer is progressively stripped from the label supply material layer under tension in a rewinding apparatus.

14-15. (canceled)

16. The method according to claim 1 wherein smaller reels of the separated label supply material layer are formed simultaneously and located side by side with spaces between the same.

17. The method according to claim 1 wherein the separated liner material layer is rewound into a reel.

18. The method according to claim 1 wherein the liner material layer does not reach the location at which the labels are applied to the articles.

19. The method according to claim 1 wherein the label supply material layer is held secure by contact means to support the same during the separation of the liner material layer therefrom.

20. The method according to claim 1 wherein control parameters used to separate the layers are different to those used to allow the separation of a label from the linerless label supply material layer at the point of application to an article.

21. The method according to claim 1 wherein the separated liner material layer is formed into an adhesive tape with on a first surface a coating of release material and, on an opposing surface, a coating of an adhesive material.

22-25. (canceled)

26. A master roll of laminate produced by a laminate manufacturer, said master roll comprising:
a label supply material layer which includes a surface for printing thereon,
an opposing surface with a layer of adhesive,
a liner material layer to which the label supply material layer is initially adhered in the master roll,
a release system between the liner material layer and label supply material layer, and
wherein said liner material layer and label supply material layer are separable and at least the label supply material layer is formed into a plurality of smaller reels for onward supply to one of more points of application of the labels therefrom to articles.

27. (canceled)

28. The master roll according to claim 26 wherein the separated liner material layer is formed into one or more reels.

29. The master roll according to claim 28 wherein the label supply material layer is slit, printed, released, coated and pre-weakened at a same location as that at which the same is separated from the liner material layer.

30. The master roll according to claim 26 wherein the liner material layer has a surface which is mechanically modified to provide lower surface energy so as to be separable from the adhesive of the label supply material layer at the separation step.

31. The master roll according to claim 26 wherein the liner material layer has a surface which is modified chemically so as to reduce surface energy and release chemistry is removable prior to the recycling of the liner material.

32. Apparatus for processing of a reel of label laminate, said apparatus comprising:
a label supply material layer and a liner material layer onto which the label supply material layer is adhered,
movement means which allow said liner material layer to act as a carrier for the label supply material layer as the laminate reel is moved to a point of separation of the label supply material layer from the liner material layer and wherein a location of separation of the label supply material layer from the liner material layer is intermediate a location of formation of the laminate and a location of a point of application of the labels defined in the label supply material layer to articles and, at the location of separation, the apparatus includes stripping means to strip the liner material layer from the label supply material layer and for winding and cutting at least the separated label supply material layer into a series of reels of a smaller width than the said laminate reel.

33-40. (canceled)
